(19) United States
(12) Patent Application Publication
(10) Pub. No.: US 2006/0048964 A1
(43) Pub. Date: Mar. 9, 2006

(54) Electrical connection system

(75) Inventor: Kevin W. Rick, Sugar Grove, IL (US)

Correspondence Address: MICHAEL P. MAZZA, LLC, 686 CRESCENT BLVD., GLEN ELYN, IL, 60137, US

(73) Assignee: RICK Electrical Contractors, Inc.

(21) Appl. No.: 10/935,782

(22) Filed: Sep. 8, 2004

(51) Int. Cl. H02G 3/14

(52) U.S. Cl. 174/66

(57) ABSTRACT

An electrical connection system which may include color-coded, temporary covers for electrical boxes, and may also include color-coded conduit identifiers such as removable caps or collars. The color-coded covers may provide origination information for the electrical box so covered, while the color-coded conduit identifiers may provide destination information for electrical conduit so identified.

### BACKGROUND OF THE INVENTION

The present invention relates to the construction industry and, more specifically, to an inexpensive, disposable, color-coded cover for temporarily covering electrical receptacles, switch boxes and the like during wall finishing such as plastering, drywalling, gypsum boarding, masonry, cementing, wooden sheathing, wooden planking, paneling, ceramic tiling, etc. to avoid their contamination during those building phases, and also to facilitate subsequent work performed by electrical tradesman. Inexpensive, disposable and color-coded conduit identifiers may also be used to facilitate electrical contractor operations.

As technology has advanced, the need for electrical power and highly desirable low voltage communications cabling such as Structured Cabling applications (i.e. voice, data, video, home theater, security, broadband, etc.) to be provided throughout a building has also increased. Currently, a typical 2000 sq. ft. single family home in the United States employs about one hundred electrical outlet boxes, switch boxes and ceiling boxes. Commonly used building materials and wall coverings include: gypsum board, drywall, exterior wooden sheathing, masonry brick, concrete, wooden planking, paneling, ceramic tile and the like. The majority of electrical boxes are installed in interior walls containing gypsum board or drywall. These electrical boxes (see, e.g., FIGS. 7-11) are usually metallic and communicate with metal conduit, or PVC and communicate with non-metallic wiring such as Romex. Other non-metallic approved raceway applications exist, but they are not common.

Raised plaster or “mud rings” (the commonly known electrical trade name for such materials), as shown in FIGS. 1-4 and 5, may also be used to ensure that there are little or no air gaps, as defined by the current 2005 National Electrical Code, between the electrical box and the finished wall covering. Such rings may also be used as supports to allow devices (e.g., (receptacles, switches, light fixtures, etc.) to be installed. The rings are typically not employed with masonry or PVC electrical boxes.

Electrical box covers are known. These covers may be installed directly over the peripheral edges of electrical boxes, in the case of masonry or PVC boxes or, more commonly, may be installed over the raised plaster rings. However, known electrical box covers suffer from several disadvantages. For example, once connected, known covers may be difficult to disconnect and may require the use of tools for such removal. They may not be economically made or designed to be reusable or disposable. Also, it may be difficult to determine the origination and/or destination locations for the electrical box and/or electrical conduit associated with a particular box cover.

Many major cities and populous counties across America mandate that metallic boxes be used with metal conduit systems, while less populous rural areas tend to permit the use of the non-metallic/PVC version. In practice, the local electrical inspector for that municipality often is the final authority on the permissible raceway systems that may be installed in a building.

As background to the invention, when an electrician wires a new home or other building, a number of typical construction activities occur, as follows. First, the electrician locates and installs outlet, switch and ceiling electrical boxes per their location indicated on the blueprints. Next, metallic conduit or non-metallic cabling (e.g., Romex) is installed, in electrical communication with the boxes. An insulating contractor then completes the insulation, and a local municipal electrical inspector then typically approves the “rough-in” work. A drywall contractor may now install drywall, taping, mudding and sanding of gypsum board joints. Final painting may occur now or later. (If a conduit system is deployed, the electrician may choose to pull the wire and collect it in the junction boxes; later, the wires will be terminated onto the devices. More commonly, following wire installation and then drywalling, etc., operations, the electrician returns to the job site to pull the wires through the conduit and box systems, and then performs the final terminations on the devices.) Installed electrical boxes will typically accumulate drywall mud deposits at this time. As many painting contractors use a spray paint method rather than a brush and roller method to apply interior paint, the boxes may likely accumulate paint residue, particularly because it is the inventor's experience that many painting contractors fail to properly cover electrical boxes prior to painting. This can leave a substantial paint build-up or over-spray in the interior of the boxes.

Drywall mud and paint overspray deposits, for example, on electrical boxes can result in improper electrical grounding conditions, in direct violation of the current 2005 National Electrical Code (2005 NEC) and the 2000 International Building Code, for example. Proper grounding of all electrical devices is strictly re-enforced throughout the current edition of the 2005 National Electrical Code (2005 NEC). For example, Article 110.12 of the 2005 NEC provides that “Internal parts of electrical equipment, including bus-bars, wiring terminals, and other surfaces, shall not be damaged or contaminated by foreign materials such as paint, plaster, cleaners, abrasives, or corrosive residues.” As another example, Article 250.12 of the 2005 NEC provides that “Nonconductive coatings (such as paint, lacquer, and enamel) on equipment to be grounded shall be removed from threads and other contact surfaces to ensure good electrical continuity or be connected by means of fittings designed so as to make such removal unnecessary.” As a final example, Article 250.96 of the 2005 NEC provides that “Any nonconductive paint, enamel, or similar coating [of grounding conductors such as metal raceways, cable trays, cable armor, cable sheath, enclosures, frames, fittings, and other metal non-current-carrying parts] shall be removed at threads, contact points, and contact surfaces or be connected by means of fittings designed so as to make such removal unnecessary.”

Improper grounding conditions caused by deposits of unwanted foreign materials may also hamper the ability of the electrician to identify how the electrical boxes are to be wired after (e.g.) the inside gypsum board or wall material is installed, since arrows or other indications for wiring on or in the vicinity of the boxes may now be partially or entirely covered by, e.g., mud or paint spray residue or deposits.

Accordingly, there is a need for a temporary, inexpensive electrical box cover to shield an electrical box during construction phases which, absent shielding, might receive substantial unwanted foreign material deposits potentially resulting in improper electrical grounding conditions and, thus, potentially serious electrical safety issues due to improper grounding of receptacles, switches, wiring, conduit systems, fixtures and/or boxes, etc. There is also a need to install safe electrical systems which comply with applicable electrical building codes. Further, there is also a need for an electrical installation system that facilitates electrical wiring (compliant to the safety intent of the 2005 NEC), reduces installation time and labor costs, and promotes quality workmanship while providing electrical safety for the dwelling or building occupants.

The present invention addresses these needs while also providing new advantages not previously obtainable with prior electrical box covers.

### SUMMARY OF THE INVENTION

The present invention provides a novel solution to the above-mentioned design considerations by providing a temporary cover for an electrical box. In one preferred embodiment, a temporary electrical box cover which is color-coded, and which is designed for removable connection to an electrical box, is provided. For example, the electrical box cover may be color-coded to designate an origination location for the electrical box. The cover, which may be made of a flexible, plastic material, may be connected to the electrical box through frictional engagement, such as by a a snap-fit connection, to the electrical box. Tabs, which may but need not be molded and integral with the cover, may be located at a periphery of the cover to facilitate engaging connection with the electrical box.

In a preferred embodiment, the cover may but need not have a geometrical shape which corresponds to that of common trade size metallic or non-metallic/PVC electrical boxes, such as one of the following shapes: circular; rectangular; or hexagonal. In a particularly preferred embodiment, the temporary electrical box covers of the invention may have various colors, such as: a green cover designating a home-run electrical box in direct electrical communication with a main electrical service panel; a yellow cover designating a downstream electrical box in electrical communication with an electrical box having a green cover; and a red cover designating a dead-end electrical box identifying the last electrical box in a chain.

Preferably, the temporary electrical box cover of the present invention is designed to be readily manually removable from the electrical box without the use of tools.

In another embodiment of the invention, the temporary electrical box cover may include one or more conduit identifier supports disposed in a direction toward the electrical box.

In a further preferred embodiment of the invention, an electrical connection system is provided which includes a temporary, color-coded electrical box cover removably connected to an electrical box, and color-coded conduit identifiers for designating conduit associated with the electrical box. Preferably, the conduit identifiers are removably engageable with one or more of the following: conduit identifier supports located on the cover; and/or electrical conduits passing through the electrical box. Useful conduit identifiers include one or more of the following: resilient, removable collars; or removable, stackable caps. The conduit identifiers may be used, for example, to designate a downstream or dead-end electrical box destination for an electrical conduit to which they are engaged. Alternatively, or in addition, a raised plaster or mud ring may be positioned adjacent the electrical box, with the temporary cover being connected to the ring.

In yet another preferred embodiment of the invention, an electrical connection system is provided which includes a temporary electrical box cover designed for removable connection to an electrical box. The cover is color-coded to designate an origination location for the electrical box. Color-coded conduit identifiers are used to designate a downstream electrical box destination for an electrical conduit to which they are engaged.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIGS. 1-2 are top views of prior art cylindrical and rectangular raised plaster rings;

FIGS. 3-4 are top views of additional prior art rectangular raised plastic rings;

FIG. 5 is a top view of a prior art, plastic cover used with an installed PVC electrical box;

FIG. 6 is a top and side perspective view of another prior art plaster ring;

FIGS. 7-8 illustrate prior art metal and PVC electrical boxes, respectively, that are commonly used in the residential building industry;

FIG. 9 shows a prior art gangable masonry electrical box which may be used with the plaster ring shown in FIG. 6;

FIGS. 10-11 are perspective views of prior art multiple gang metal electrical boxes, respectively;

FIG. 12 is a color-coded, schematic diagram illustrating one preferred color scheme for electrical box covers according to the present invention;

FIGS. 13-14 are perspective views of a preferred temporary electrical box cover embodiment according to the present invention;

FIG. 15 is a rear view of the temporary box cover embodiment shown in FIGS. 13-14;

FIG. 16 is a side, cross-sectional view along arrows 15-15 of the temporary box cover embodiment shown in FIG. 15; and

FIG. 17 is a top view of the temporary box cover embodiment shown in FIG. 15.

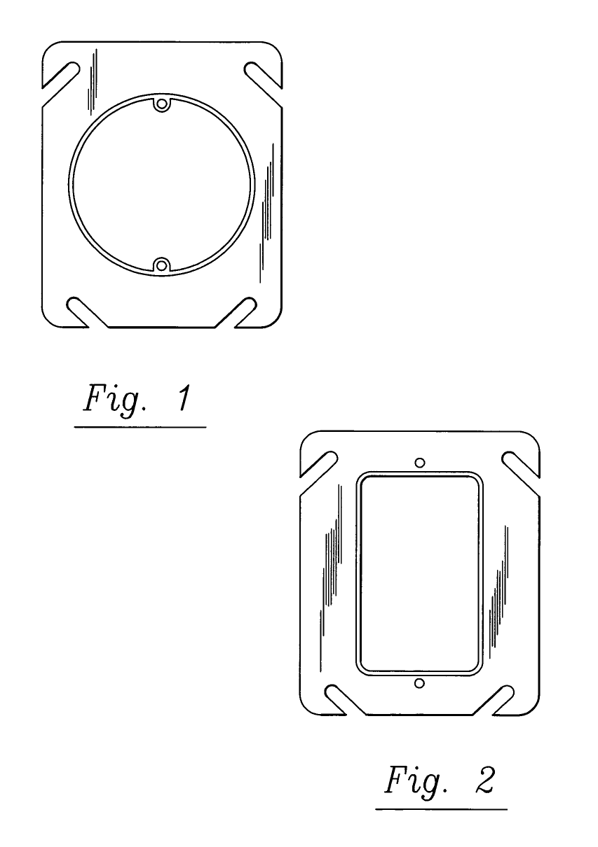

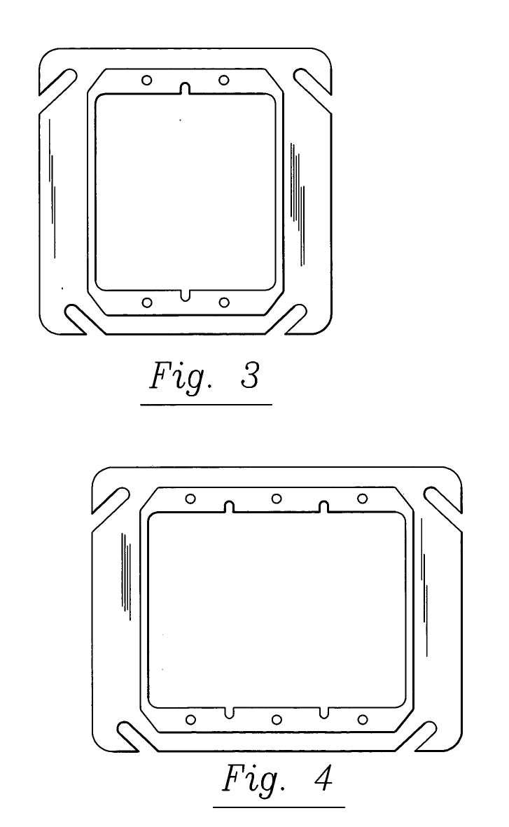

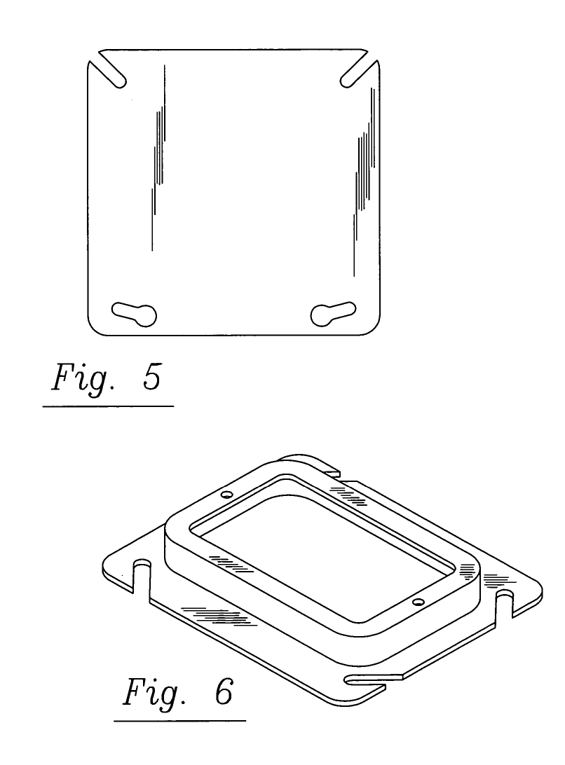

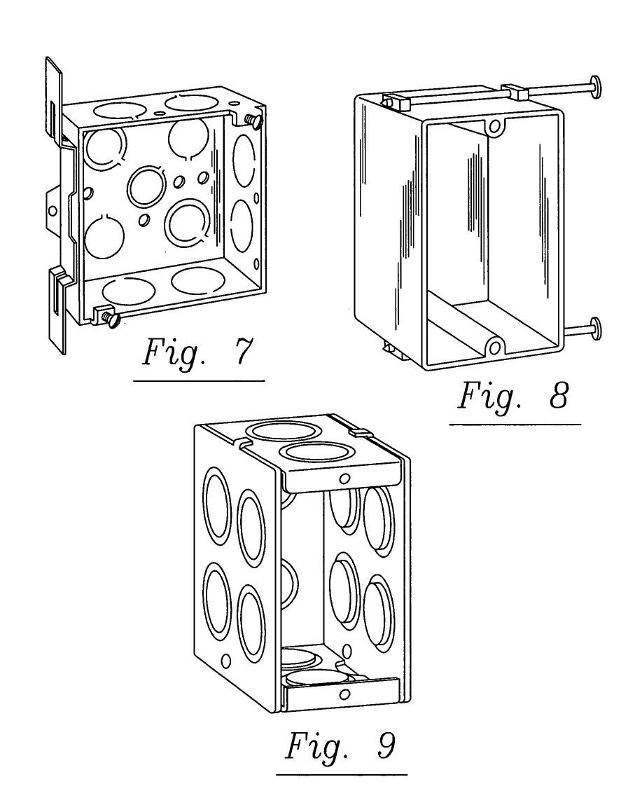

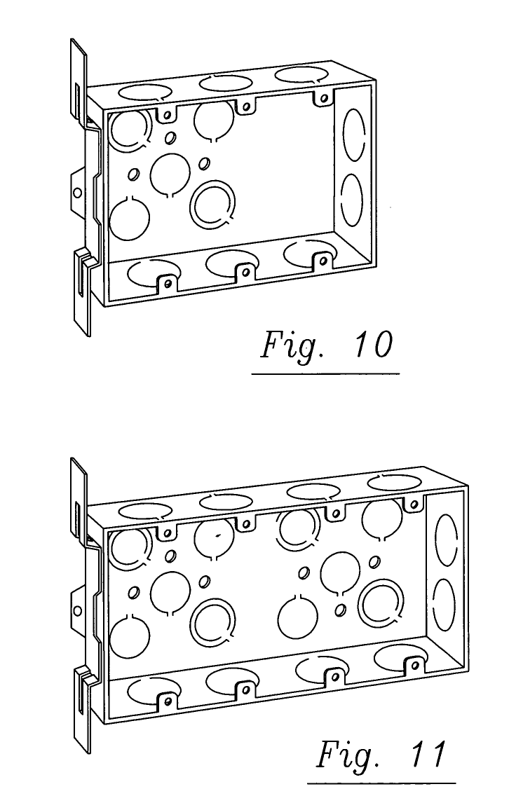

### DEFINITION OF CLAIM TERMS

The following terms are used in the claims of the patent as filed and are intended to have their broadest meaning consistent with the requirements of law.

“Electrical box” means electrical outlet boxes, junction boxes, switch boxes, ceiling boxes, fixture boxes, pull boxes, splice boxes and the like, designed to provide a meeting point for a plurality of electrical conduits and/or or connections.

“Main electrical service panel” means a location where power originates from an electrical utility and houses the branch electrical, appliance circuits, fuses or circuit breakers, typically with a main circuit breaker or fuse disconnect shutoff for electrical power.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

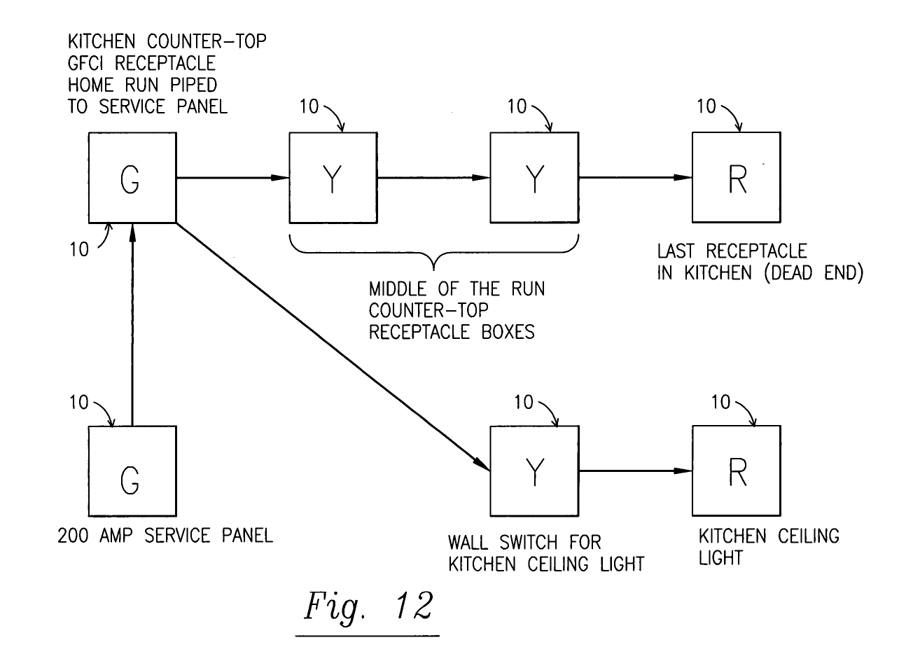

In accordance with one embodiment of this invention, and referring now to FIGS. 12-17, temporary electrical covers according to one preferred embodiment of the present invention, and designated generally with the reference numeral 10, are shown. Referring to FIG. 12, color-coded covers 10 are preferably employed, using a color-coding scheme familiar to electricians as further explained below, with “G” referring to a temporary cover colored green, “Y” referring to yellow and “R” to red. Of course, other colors may be used, as well.

Preferably, temporary box cover 10 should be made relatively inexpensively so that it may be economically disposable. Also, preferably, the cover is made out of a flexible plastic sheet material such as a flexible, resilient polymeric material. The temporary cover may be made of clear or translucent materials, or of opaque materials, depending on whether or not there is a need to view the interior of the electrical box. A preferred plastic cover may be manufactured by injection-molding, for example.

Referring again to FIG. 12, the electrical box according to the present invention preferably employs a common, universally-recognized color-coding system such as green, yellow and red. In addition, by using the color-coded temporary electrical box cover of the present invention, a quick visual glance is all that is necessary to identify the “home-run,” “downstream” and “dead-end” electrical boxes being utilized. For example, the first electrical box that is wired or piped in conduit from the main electrical panel, i.e., the “home-run” box, may include a temporary electrical cover that is green. “Downstream” or subsequent electrical boxes may be identified using a yellow temporary plastic cover. The last electrical box, the so-called “dead-end” or end-of-the-chain box, may be identified using a red cover. This simple color-coding scheme allows the electrician to easily identify how the electrical devices (e.g. receptacles, lighting fixtures, switches) may be wired and/or terminated after, e.g., the inside gypsum board is installed.

The box covers are preferably temporary, affordable and reusable. Once the drywall is installed, mudded, sanded and painted, the box covers may be removed, allowing the electrician to trim out the electrical boxes using approved plastic, metal or wood box covers given the device configuration. The box covers may then be reused at another site.

Preferably, the box cover is sized to be captured frictionally within standard sizes of electrical receptacle boxes and the like, with no more than the thickness of the cover sheet material protruding past the plane of the wall surface, in order to provide as little disruption as possible during the plastering or other operations of the wall. Preferably, the box cover may be snap-fit, for example, such that no special tools are necessary to install it.

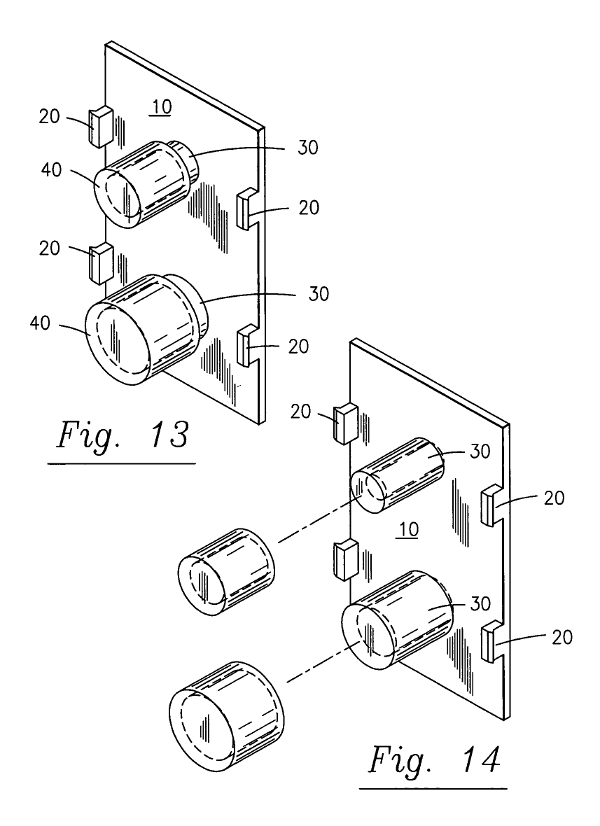

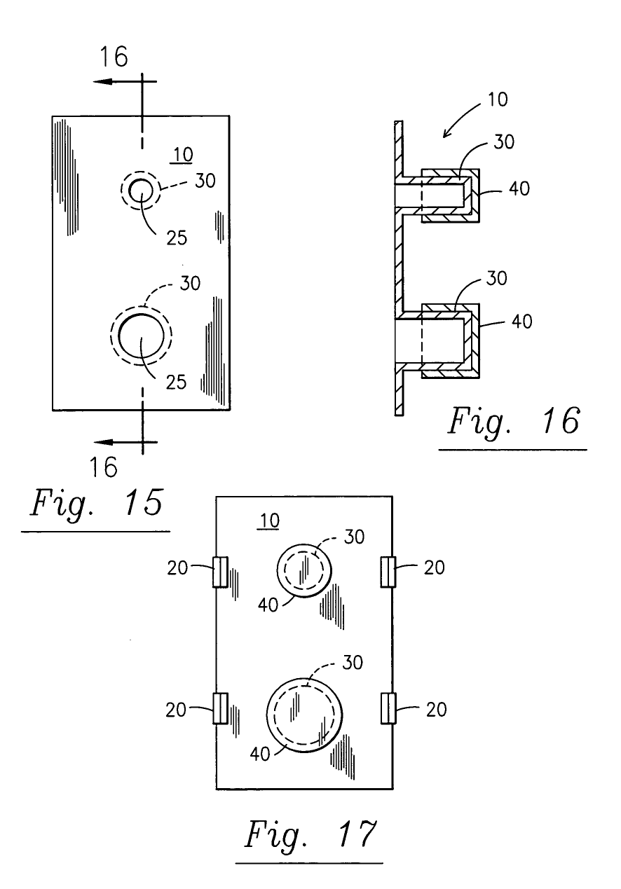

In order to facilitate the manual (hands-only) removal of the temporary electrical box cover, a means of a quick disconnect without using such tools as screwdrivers, pliers, etc is highly desired. This may be accomplished by molding the temporary plastic electrical box cover of the present invention to include one or more extruded side snaps. For example, and referring now to FIGS. 13-17, cover 10 may include apertures 25 (see FIG. 15, e.g., one-half and three-quarter inches, respectively) for accommodating conduit, and molded side snaps 20 designed to snap-fit over the peripheral edges of the corresponding, mating electrical box. In addition, cover 10 may include extruded cylindrical shapes 30 which are located to protrude toward the metal electrical box. Cylinders 30 may be closed or not. Removable, color-coded plastic caps or resilient collars 40 may be snap-fit on cylinders 30, as best shown in FIGS. 13-14 and 16. The color of caps or collars 40 may be used by an electrician to determine the use/location of an adjacent conduit. Alternatively, caps or collars 40 may be removed from cylinders 30 and placed directly on a corresponding conduit to identify that specific conduit directly.

Cover 10 with side snaps 20 and extruded shapes 30 may be manufactured using a plastic injection molding process, for example.

Removable, pressure-fit plastic conduit caps or collars 40 may be used to identify the respective home-run conduits back to the main electrical service panel, and also to separately identify the downstream (e.g., yellow) and dead-end (e.g., red) conduits. Preferably, plastic conduit caps or collars 40 follow the same color code concept used with the temporary plastic electrical box covers (e.g., green, yellow and red as identified above).

To take a specific, non-limiting hypothetical example, a kitchen electrical box might have a green temporary electrical cover to indicate that the kitchen box runs from a home-run main electrical service panel box in the basement. Removing the green cover of the kitchen box might reveal two conduits: one with a red collar indicating that it runs to a dead-end wall switch box, and the other with a yellow collar indicating that it runs to a kitchen counter-top box used to power appliances.

In actual use, one box may have numerous conduits running into it. Accordingly, multiple caps or collars 40 may be stored on cylinders 30 of temporary cover 10. Each conduit may then be color-coded using a different collar. After plastering, etc., operations, cover 10 may be removed to reveal the color-coded conduits bearing collars 40, for example, allowing the conduits to be easily identified.

Referring back to FIGS. 13-17, shapes 30 may of course be non-cylindrical, such as rectangular or other shapes. A cylindrical cross-section may be preferred for both shapes 30 and caps or collars 40, as this will facilitate the removable but secure attachment of collars 40 to both shapes 30 and conduit with its typically cylindrical cross-sectional shape. Caps or collars 40 are preferably sized to securely but removably be snap-fit over shapes 30 and the electrical conduit. Shapes 30 may be sized to generally correspond to the conduit size. Shapes 30 may extend, for example, about five-eighths of an inch from the outer surface of cover 10 toward the back of the corresponding metal electrical box. It is envisioned that most people pulling on or removing the temporary cover may have their hand oriented such that the thumb is lower than the forefinger when the thumb and forefinger are in a vertical orientation. This provides an opportunity for the thumb to grasp the cap or collar 40 corresponding to the (e.g.) three-quarter inch conduit, whereas the cap or collar 40 corresponding to the (e.g.) one-half inch conduit may be grasped by the forefinger.

Electrical box cleanup during wiring and/or device installation may also be eliminated using the box covers of the present invention.

It will be appreciated that various changes to the preferred embodiment shown in the drawings may be made while keeping within the spirit of the invention. Such changes and modifications constituting unsubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

1. A temporary electrical box cover designed for removable connection to an electrical box, wherein the cover is color-coded to designate an origination location for the electrical box.

2. (canceled)

3. The temporary electrical box cover of claim 1, wherein the cover connects to the electrical box through frictional engagement.

4. The temporary electrical box cover of claim 1, wherein the cover is in a snap-fit connection with the electrical box

5. The temporary electrical box cover of claim 1, wherein the cover is made of a flexible plastic material.

6. The temporary electrical box cover of claim 1, further comprising tabs located at a periphery of the cover for engaging connection with the electrical box.

7. The temporary electrical box cover of claim 6, wherein the tabs are molded and integral with the cover.

8. The temporary electrical box cover of claim 1, wherein the cover has a geometrical shape which corresponds to that of common trade size metallic or non-metallic electrical boxes.

9. The temporary electrical box cover of claim 8, wherein the cover has a geometrical shape chosen from one of the following shapes: circular; rectangular; or hexagonal.

10. The temporary electrical box cover of claim 1, wherein the cover is colored with at least one of the following colors: green; yellow; and red.

11. The temporary electrical box cover of claim 10, wherein a green cover designates a home-run electrical box in direct electrical communication with a main electrical service panel.

12. The temporary electrical box cover of claim 10, wherein a yellow cover designates a downstream electrical box in electrical communication with an electrical box having a green cover.

13. The temporary electrical box cover of claim 10, wherein a red cover designates a dead-end electrical box identifying the last electrical box in a chain.

14. The temporary electrical box cover of claim 1, wherein the temporary cover is readily manually removable from the electrical box without the use of tools.

15. The temporary electrical box cover of claim 1, wherein the cover comprises one or more conduit identifier supports disposed in a direction toward the electrical box.

16. An electrical connection system, comprising a temporary, color-coded electrical box cover removably connected to an electrical box, wherein the cover is color-coded to designate an origination location for the electrical box, and further comprising color-coded conduit identifiers for designating conduit associated with the electrical box.

17. The electrical connection system of claim 16, wherein the conduit identifiers are removably engageable with one or more of the following: conduit identifier supports located on the cover; electrical conduits passing through the electrical box.

18. The electrical connection system of claim 17, wherein the conduit identifiers comprise one or more of the following: resilient, removable collars; removable, stackable caps.

19. The electrical connection system of claim 16, wherein the conduit identifiers designate a downstream or dead-end electrical box destination for an electrical conduit to which they are engaged.

20. The electrical connection system of claim 16, further comprising a raised plaster or mud ring positioned adjacent the electrical box, the temporary cover being connected to the ring.

21. An electrical connection system, comprising a temporary electrical box cover designed for removable connection to an electrical box, wherein the cover is color-coded to designate an origination location for the electrical box, and further comprising color-coded conduit identifiers designating a downstream electrical box destination for an electrical conduit to which they are engaged.
